(19) United States
(12) Patent Application Publication
(10) Pub. No.: US 2025/0001739 A1
(43) Pub. Date: Jan. 2, 2025

(54) LIQUID CRYSTAL FILM FOR AUTOMOTIVE GLASS

(71) Applicant: WICUE USA INC., Santa Clara, CA (US)

(72) Inventors: Fenghua LI, Santa Clara, CA (US); Osamu YAMADA, Santa Clara, CA (US); Cai GUO, Santa Clara, CA (US)

(73) Assignee: WICUE USA INC., Santa Clara, CA (US)

(21) Appl. No.: 18/263,343

(22) PCT Filed: Jun. 3, 2023
(86) PCT No.: PCT/US2023/024380

§ 371 Date: Jul. 28, 2023

Related U.S. Application Data
(60) Provisional application No. 63/355,849, filed on Jun. 27, 2022.

(51) Int. Cl. B32B 27/08; B32B 3/12; B32B 7/12

(52) U.S. Cl. CPC B32B 27/08; B32B 3/12; B32B 7/12; B32B 2307/202; B32B 2307/7376; B32B 2605/006

(57) ABSTRACT

A liquid crystal film for automotive glass is provided. The liquid crystal film includes a first base layer, a first conductive layer disposed on the first base layer, a second base layer opposite to the first base layer, a second conductive layer disposed on a side of the second base layer close to the first conductive layer, and a liquid crystal layer disposed between the first conductive layer and the second conductive layer. The liquid crystal layer includes a plurality of spacers, and a liquid crystal mixture; the plurality of spacers is perpendicularly disposed between the first conductive layer and the second conductive layer, and divides a space between the first conductive layer and the second conductive layer into a plurality of lattices; and the liquid crystal mixture is filled in the plurality of lattice. A shape of each of the plurality of lattices is polygonal.

### TECHNICAL FIELD

The present disclosure relates to the technical field of liquid crystal films, in particular to a liquid crystal film for automotive glass.

### BACKGROUND

With the development of modern science and technology, the fields of glass application are more and more extensive, especially in automotive glass. There are many places where glass can be used in cars, such as front and rear windshields, door and window glass, and sunroof glass. These glasses form a relatively closed whole inside the cabin, which plays the role of shielding from wind and rain, maintaining the temperature in the car and allowing the occupants in the car to observe the surrounding environment. With the advancement and breakthrough in the material technology of automotive glass, more new functional automotive glass appears, for example, dimmable automotive glass.

At present, the dimmable automotive glass is generally prepared by disposing two ordinary glasses opposite to each other, and sandwiching a liquid crystal layer between the two ordinary glasses. The automotive glass generally has a certain curvature, as such, the liquid crystal layer is subjected to a certain bending during laminating under high temperature and high pressure. The liquid crystal layer is prone to have bubbles and delamination during bending, which leads to an unqualified automotive glass. The dimming effect of the automotive glass cannot be achieved.

The dimmable automotive glass is also made by sandwiching a liquid crystal dimmable film between the two ordinary glasses. The liquid crystal dimmable film is generally provided with a first substrate, a first conductive layer, a liquid crystal material layer, a second conductive layer, and a third conductive layer, and a second substrate. The liquid crystal material layer is cured between the two conductive layers by UV-curing liquid crystal mixture and glue. However, the liquid crystal dimmable film is prone to various problems, for example, unstable internal structure, during laminating under high temperature and high pressure. During laminating under high temperature and high pressure, the dimmable film is deformed to a certain extent, and the thickness of the dimmable film is changed uneven, thereby resulting in the unstable internal structure.

### SUMMARY

A purpose of the present disclosure is to provide a liquid crystal film for automotive glass includes a first base layer; a first conductive layer disposed on the first base layer; a second base layer opposite to the first base layer; a second conductive layer disposed on a side of the second base layer close to the first conductive layer; and a liquid crystal layer disposed between the first conductive layer and the second conductive layer. The liquid crystal layer includes a plurality of spacers, and a liquid crystal mixture; the plurality of spacers is perpendicularly disposed between the first conductive layer and the second conductive layer, and divides a space between the first conductive layer and the second conductive layer into a plurality of lattices; and the liquid crystal mixture is filled in the plurality of lattices. A shape of each of the plurality of lattices is polygonal.

In some embodiments, the liquid crystal layer further includes a bottom plate, the bottom plate is disposed on the second conductive layer, and the plurality of spacers is perpendicularly disposed between the bottom plate and the second conductive layer and divides a space between the bottom plate and the second conductive layer into the plurality of lattices.

In some embodiments, the bottom plate and the plurality of lattices are integrally formed by a curing glue.

In some embodiments, the shape of each of the plurality of lattices is regular hexagonal.

In some embodiments, the shape of each of the plurality of lattices is regular quadrilateral.

In some embodiments, a thickness of the bottom plate ranges from 0.01 μm to 10 μm

In some embodiments, a thickness of each of the plurality of spacers ranges from 5 μm to 10 μm.

In some embodiments, a maximum diameter of the shape of each of the plurality of lattices ranges from 30 μm to 10 mm.

In some embodiments, the liquid crystal mixture is formed by mixing liquid crystal, chiral agent and glue.

In some embodiments, the liquid crystal mixture is formed by mixing liquid crystal, chiral agent and microparticles.

In some embodiments, the liquid crystal is selected from any one of GH liquid crystal, TN liquid crystal, VA liquid crystal, ECB liquid crystal, PDLC liquid crystal, PNLC liquid crystal, or PSCT liquid crystal.

In some embodiments, the first base layer and the second base layer are PET films or PC boards.

In some embodiments, the first conductive layer and the second conductive layer are transparent conductive layers.

Another purpose of the present disclosure is to provide A preparation method for liquid crystal film for automotive glass includes providing a first base layer and a second base layer; disposing a first conductive layer on the first base layer, and disposing a second conductive layer on the second base layer; spraying a curing glue on the second conductive layer, and imprinting a plurality of spacers on the second conductive layer by a mold, wherein a plurality of lattices is defined by the plurality of spacers; preparing a liquid crystal mixture, and filing the liquid crystal mixture into the plurality of lattices; covering the plurality of spacers and the plurality of lattices with the first base layer and the first conductive layer, wherein first conductive layer is disposed on tops of the plurality of spacers; and sealing edges of the first base layer, the first conductive layer, the liquid crystal layer, the second conductive layer, and the second base layer.

In some embodiments, the spraying a curing glue on the second conductive layer, and imprinting a plurality of spacers on the second conductive layer by a mold further includes imprinting a bottom plate on the second conductive layer by a same mold.

In some embodiments, the liquid crystal mixture is prepared by mixing liquid crystal, chiral agent and glue.

In some embodiments, the liquid crystal mixture is prepared by mixing liquid crystal, chiral agent and microparticles.

In some embodiments, the liquid crystal is selected from any one of GH liquid crystal, TN liquid crystal, VA liquid crystal, ECB liquid crystal, PDLC liquid crystal, PNLC liquid crystal, or PSCT liquid crystal.

In some embodiments, a shape of each of the plurality of lattices is regular hexagonal.

In some embodiments, a shape of each of the plurality of lattices is regular quadrilateral.

### BRIEF DESCRIPTION OF THE DRAWINGS

In order that the technical solution in the embodiments of the present disclosure may be explained more clearly, references will now be made briefly to the accompanying drawings required for the description of the embodiments. The accompanying drawings in the following description are merely some of the embodiments of the present disclosure, and other drawings may be made to those skilled in the art without involving any inventive effort.

FIG. 1 is a schematic structural diagram of a liquid crystal film for automotive glass according to an embodiment of the present disclosure.

FIG. 2 is a schematic structural diagram of a liquid crystal layer and a first conductive layer of a liquid crystal film for automotive glass according to an embodiment of the present disclosure.

FIG. 3 is a schematic structural diagram of a liquid crystal film for automotive glass according to another embodiment of the present disclosure.

FIG. 4 is a schematic structural diagram of a liquid crystal layer and a first conductive layer of a liquid crystal film for automotive glass according to an embodiment of the present disclosure.

FIG. 5 is a schematic structural diagram of a liquid crystal layer and a first conductive layer of a liquid crystal film for automotive glass according to yet another embodiment of the present disclosure.

### DETAILED DESCRIPTION OF THE EMBODIMENTS

The technical solutions in the embodiments of the present disclosure will be clearly and completely described below with reference to the accompanying drawings in the embodiments of the present disclosure. The described embodiments are only a part of the embodiments of the present disclosure, not all of the embodiments. Based on the embodiments of the present disclosure, all other embodiments obtained by those of ordinary skill in the art without creative efforts shall fall within the protection scope of the present disclosure.

It should be noted that if there are directional indications (such as up, down, left, right, front, back) involved in the embodiments of the present disclosure, then, the directional indication is only used to explain the relative positional relationship, movement situation, etc. among the components under a certain posture (as shown in the attached image). If the specific posture changes, the directional indication changes accordingly.

In addition, if there are descriptions involving “first”, “second”, etc. in the embodiments of the present disclosure, the descriptions of “first”, “second”, etc. are only used for description purposes, which should not be understood as indicating or implying their relative importance or implying the number of technical features indicated. Thus, a feature delimited with “first”, “second” may expressly or implicitly include at least one of that feature. In addition, the technical solutions between the various embodiments can be combined with each other, but must be based on the realization by those of ordinary skill in the art. When the combination of technical solutions contradicts each other or cannot be realized, it should be considered that such combination of technical solutions does not exist and is not within the protection scope of the present disclosure.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

In the description of the disclosure, unless expressly defined and defined otherwise, terms such as “connected with”, “connected to”, “mounted”, “fixed” and the like are to be understood in a broad sense, for example, may be fixedly connected, detachably connected, or as a whole; may be mechanically connected or electrically connected; may be directly connected, indirectly connected through an intermediate medium, connected inside the two elements or interacted between the two elements. It will be appreciated by those of ordinary skill in the art that the foregoing may be understood as a specific meaning within the present application, depending on the specific circumstances.

### Example 1

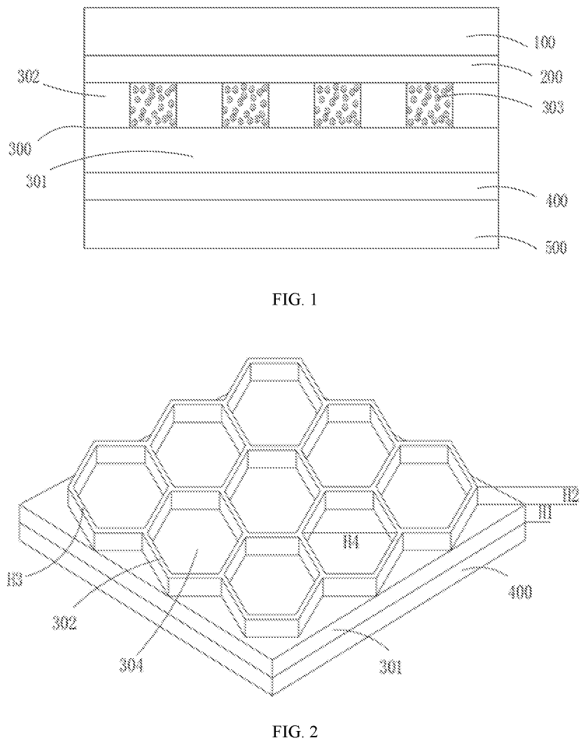

Referring to FIG. 1 and FIG. 2, the present disclosure provides a liquid crystal film for automotive glass, wherein the liquid crystal film for automotive glass includes a first base layer 100, a first conductive layer 200, a liquid crystal layer 300, a second conductive layer 400, and a second base layer 500. The first conductive layer 200 is attached to the first base layer 100, and the second conductive layer 400 is attached to the second base layer 500. The first conductive layer 200 is opposite to the second conductive layer 400, and the liquid crystal layer 300 is disposed between the first conductive layer 200 and the second conductive layer 400.

The liquid crystal layer 300 includes a bottom plate 301, a plurality of spacers 302, and a liquid crystal mixture 303. The bottom plate 301 is disposed on the second conductive layer 400, the plurality of spacers 302 is perpendicularly disposed on the bottom plate 301, and the first conductive layer 200 is disposed on the plurality of spacers 302. The plurality of spacers 302 divides a space between the bottom plate 301 and the first conductive layer 200 into a plurality of lattices 304, and the liquid crystal mixture 303 is filled into the plurality of lattices 304. In an embodiment, a shape of each of the plurality of lattices 304 is polygonal.

In an embodiment, tops of the plurality of spacers 302 are bonded to the first conductive layer 200. Further, tops of the plurality of spacers 302 are firmly adhered to the first conductive layer 200, and bottoms of the plurality of spacers 302 are firmly adhered to the bottom plate 301. Bottom of the bottom plate 301 is bonded to the second conductive layer 400. As such, the liquid crystal layer 300, the first conductive layer 200 and the second conductive layer 400 are combined into a stable whole, thereby ensuring the thickness of the liquid crystal layer 300 consistent during the lamination, and preventing the thickness of the liquid crystal film from being locally increased or decreased due to bending.

The liquid crystal layer 300, the first conductive layer 200 and the second conductive layer 400 together provide a stable and strong structure. The structure is well adapted to the lamination process with high temperature and high pressure in the production of automotive glass. The lattices defined by the spacers support the liquid crystal mixture, and prevent the liquid crystal molecules from sinking and sagging. As such, the dimming effect is improved. Moreover, with the spacers in the liquid crystal layer, the liquid crystal film can be bent while maintaining the same thickness, which is more suitable for roll-to-roll production.

Referring to FIG. 2, in an embodiment, a shape of each of the plurality of lattices 304 is a regular hexagonal, to have a higher strength and better resistance to high temperature and high pressure.

In an embodiment, the thickness H1 of the bottom plate 301 ranges from 0.01 μm to 10 μm. In this embodiment, the thickness H1 of the bottom plate 301 is optionally 10 μm. The thickness H2 of each of the plurality of spacers 302 ranges from 5 μm to 10 μm. In this embodiment, the thickness H2 of each of the plurality of spacers 302 is optionally 10 μm. The width H3 of each of the plurality of spacers 302 is 10 μm.

Further referring to FIG. 2, in the embodiment of the shape of each of the plurality of lattices 304 being regular hexagonal, the maximum diameter H4 of each of the plurality of lattices 304 ranges from 30 μm to 10 mm, and optionally the maximum diameter H4 is 5 mm.

In an embodiment, the bottom plate 301 and the plurality of spacers 302 are integrally formed by curing glue, optionally by UV curing glue. The UV curing glue is sprayed on the second conductive layer 400, and a mold with shapes of the bottom plate 301 and the spacers 302 is used to print on the sprayed UV curing glue. Then, the glue is cured by being irradiated with UV lights to form the bottom plate 301 and the spacers 302. The bottom plate 301 can separate the liquid crystal mixture 303 in the lattices 304 from the second conductive layer 400, to provide a good insulating effect.

In an embodiment, the liquid crystal mixture 303 is obtained by mixing liquid crystal, chiral agents, and microparticles. The chiral agent is commonly used in the market, such as chiral agent S811. The microparticles are transparent and have little effect on light refraction, such as silicon spheres.

Further, the liquid crystal used in the liquid crystal mixture 303 may be selected from guest host (GH) liquid crystal, twisted nematic (TN) liquid crystal, vertically aligned (VA) liquid crystal, electronically controlled birefringence (ECB) liquid crystal, polymer-dispersed liquid crystal (PDLC) liquid crystal, polymer network liquid crystal (PNLC) liquid crystal, or polymer stabilized cholesteric texture (PSCT) liquid crystal.

In an embodiment, GH liquid crystal is used in the liquid crystal mixture 303, in order to achieve stepless dimming for better experience. A guest-host relationship is defined in the liquid crystal layer by mixing GH liquid crystal and the dichroic dye, wherein the GH liquid crystal is the host (Host), and the dichroic dye is the guest (Guest). Under an external electrical field, the dye molecules rotate with the liquid crystal molecules, and the dichroic dye has the anisotropy of light absorbance. According to the azimuthal relationship between the absorption axis of the dye molecule and the molecular axis of the dye molecule, the dichroic dye classifies as positive (P-type) dichroic dyes and negative (N) dichroic dyes. When the polarization direction of the lights is perpendicular to the absorption axis of the dye molecule, the lights are substantially transmitted. However, when the polarization direction of the lights is parallel to the absorption axis of the dye molecule, the lights are substantially absorbed. This type of dichroic dye is a positive dichroic dye, and the negative dichroic dye is just the opposite. The lights are absorbed or transmitted based on the characteristics of the positive and negative dichroic dyes, thereby changing the transmittance of the liquid crystal layer 300. The GH liquid crystal can selectively transmit the lights with a dichroic dye and without a polarizer. The liquid crystal layer 300 can achieve the dimming of the liquid crystal film and maintain high transparency of the liquid crystal film. The color of the liquid crystal film can also be adjusted by the color of the dichroic dye. In another embodiment, if privacy glass is needed, PDLC liquid crystal, PNLC liquid crystal, or PSCT liquid crystal may be selected, and the PNLC liquid crystal is optionable.

In an embodiment, the first base layer 100 and the second base layer 500 are PET films. Other materials suitable for the base material can be selected as the base layer according to the needs of the actual situation, for example, transparent PC board or transparent glass.

Further, the first conductive layer 200 and the second conductive layer 400 are transparent conductive layers. Optionally, the first conductive layer 200 and the second conductive layer 400 are both indium tin oxide (ITO) conductive layers. The first conductive layer 200 is a transmitting electrode, and the second conductive layer 400 is a receiving electrode, so that a stable electric field is generated between the first conductive layer 200 and the second conductive layer 400. Electrical charges can flow from the transmitting electrode 200, through the liquid crystal layer 300 including the liquid crystal mixture 303, to the receiving electrode 400. In this way, the liquid crystal layer 300 can be stably driven to change states. The liquid crystal film for automobile glass also includes a controller (not shown in the Figures), and the controller is provided with a control circuit. The first conductive layer 200 and the second conductive layer 400 are electrically connected to the control circuit, and the electric field between the first conductive layer 200 and the second conductive layer 400 is controlled by the controller.

A preparation method for liquid crystal film for automotive glass is provided, and the steps of an embodiment according to the preparation method are as follows.

Step 1: two transparent PET films are selected as a first base layer 100 and a second base layer 500, respectively. An ITO conductive layer is plated on a side of the first base layer 100 to obtain a first conductive layer 200, and an ITO conductive layer is plated on a side of the second base layer 200 to obtain a second conductive layer 400.

Step 2: a curing glue is sprayed on the second conductive layer 400, a mold with shapes of a bottom plate and a spacer is used to print on the sprayed curing glue. The glue is cured by being irradiated with UV lights to form a bottom plate 301 and a plurality of spacers 302 on the second conductive layer 400.

Step 3: a liquid crystal mixture 303 is obtained by mixing with liquid crystal, chiral agent, and the microparticles. The liquid crystal is selected as GH liquid crystal.

Step 4: the liquid crystal mixture 303 is filled into a plurality of lattices 304 divided by the spacers 302.

Step 5: the first base layer 100 and the first conductive layer 200 are covered over the spacers 302. The first conductive layer 200 is disposed on tops of the spacers 302.

Step 6: edges of the first base layer 100, the first conductive layer 200, the liquid crystal layer 300, the second conductive layer 400, and the second base layer 500 are sealed.

The above-mentioned steps are a brief description of the preparation method for liquid crystal film for automotive glass in the present disclosure, and the sequence of steps 1 to 6 should not be interpreted as limit to the present disclosure.

### Example 2

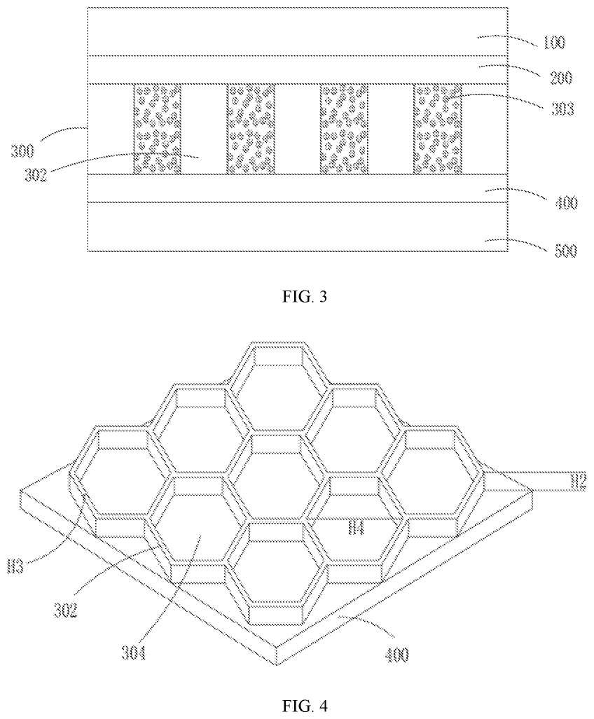

As shown in FIG. 3 and FIG. 4, the present disclosure provides a liquid crystal film for automotive glass, wherein the liquid crystal film for automotive glass includes a first base layer 100, a first conductive layer 200, a liquid crystal layer 300, a second conductive layer 400, and a second base layer 500. The first conductive layer 200 is attached to the first base layer 100, and the second conductive layer 400 is attached to the second base layer 500. The first conductive layer 200 is opposite to the second conductive layer 400, and the liquid crystal layer 300 is disposed between the first conductive layer 200 and the second conductive layer 400.

The liquid crystal layer 300 includes a plurality of spacers 302, and a liquid crystal mixture 303. In an embodiment, tops of the plurality of spacers 302 are firmly adhered to the first conductive layer 200, and bottoms of the plurality of spacers 302 are firmly adhered to the second conductive layer 400. The plurality of spacers 302 divides a space between the first conductive layer 200 and the second conductive layer 400 into a plurality of lattices 304, and the liquid crystal mixture 303 is filled into the plurality of lattices 304. In an embodiment, a shape of each of the plurality of lattices 304 is polygonal.

Referring to FIG. 4, in an embodiment, a shape of each of the plurality of lattices 304 is a regular hexagonal, to have a higher strength and better resistance to high temperature and high pressure.

The difference between Example 2 and Example 1 is that the liquid crystal layer 300 is disposed in the first conductive layer 200 and the second conductive layer 400, and no bottom plate 301 as Example 1 is provided. The tops and bottoms of the spacers 302 are directly attached to the first conductive layer 200 and the second conductive layer 400, respectively. The preparation method for liquid crystal film for automotive glass of Example 2 is basically same as those of Example 1, excluding that, in step 2, curing glue is sprayed on the second conductive layer 400, and a mold with shapes of spacers is used to print on the sprayed curing glue. The glue is cured by being irradiated with UV light to form a plurality of spacers 302 on the second conductive layer 400.

### Example 3

Referring to FIG. 1 to FIG. 4, the present disclosure provides a liquid crystal film for automotive glass, wherein the liquid crystal film for automotive glass includes a first base layer 100, a first conductive layer 200, a liquid crystal layer 300, a second conductive layer 400, and a second base layer 500. The first conductive layer 200 is attached to the first base layer 100, and the second conductive layer 400 is attached to the second base layer 500. The first conductive layer 200 is opposite to the second conductive layer 400, and the liquid crystal layer 300 is disposed between the first conductive layer 200 and the second conductive layer 400.

As shown in FIG. 1 and FIG. 2, the liquid crystal layer 300 includes a bottom plate 301, a plurality of spacers 302, and a liquid crystal mixture 303. The bottom plate 301 is disposed on the second conductive layer 400, the plurality of spacers 302 is perpendicularly disposed on the bottom plate 301, and the first conductive layer 200 is disposed on the plurality of spacers 302. The plurality of spacers 302 divides a space between the bottom plate 301 and the first conductive layer 200 into a plurality of lattices 304, and the liquid crystal mixture 303 is filled into the plurality of lattices 304. In an embodiment, a shape of each of the plurality of lattices 304 is polygonal. Referring to FIG. 2, in an embodiment, a shape of each of the plurality of lattices 304 is a regular hexagonal.

As shown in FIG. 3 and FIG. 4, the liquid crystal layer 300 includes a plurality of spacers 302, and a liquid crystal mixture 303. Tops of the plurality of spacers 302 are firmly adhered to the first conductive layer 200, and bottoms of the plurality of spacers 302 are firmly adhered to the second conductive layer 400. The plurality of spacers 302 divides a space between the first conductive layer 200 and the second conductive layer 400 into a plurality of lattices 304, and the liquid crystal mixture 303 is filled into the plurality of lattices 304. In an embodiment, a shape of each of the plurality of lattices 304 is polygonal. Referring to FIG. 4, in an embodiment, a shape of each of the plurality of lattices 304 is a regular hexagonal.

The difference between Example 3 and Example 1 or Example 2 is that the liquid crystal mixture 303 is made by mixing GH liquid crystal, chiral agent and glue. The preparation method for liquid crystal film for automotive glass of Example 3 is basically same as those of Example 1 or Example 2, excluding that, in step 3, the liquid crystal mixture 303 is obtained by mixing with GH liquid crystal, chiral agent, and the light-curing glue. As such, the tops of the spacers 302 are directly bonded to the first conductive layer 200 during laminating the first base layer 100 with the second base layer 500.

### Example 4

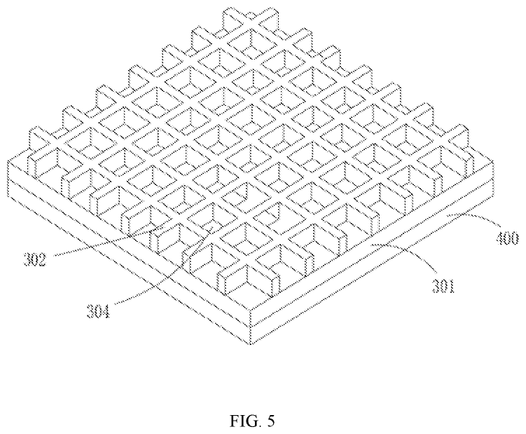

Referring to FIG. 1, FIG. 3 and FIG. 5, the present disclosure provides a liquid crystal film for automotive glass, wherein the liquid crystal film for automotive glass includes a first base layer 100, a first conductive layer 200, a liquid crystal layer 300, a second conductive layer 400, and a second base layer 500. The first conductive layer 200 is attached to the first base layer 100, and the second conductive layer 400 is attached to the second base layer 500. The first conductive layer 200 is opposite to the second conductive layer 400, and the liquid crystal layer 300 is disposed between the first conductive layer 200 and the second conductive layer 400.

As shown in FIG. 1, the liquid crystal layer 300 includes a bottom plate 301, a plurality of spacers 302, and a liquid crystal mixture 303. The bottom plate 301 is disposed on the second conductive layer 400, the plurality of spacers 302 is perpendicularly disposed on the bottom plate 301, and the first conductive layer 200 is disposed on the plurality of spacers 302. The plurality of spacers 302 divides a space between the bottom plate 301 and the first conductive layer 200 into a plurality of lattices 304, and the liquid crystal mixture 303 is filled into the plurality of lattices 304. In an embodiment, a shape of each of the plurality of lattices 304 is polygonal.

As shown in FIG. 3, the liquid crystal layer 300 includes a plurality of spacers 302, and a liquid crystal mixture 303. Tops of the plurality of spacers 302 are firmly adhered to the first conductive layer 200, and bottoms of the plurality of spacers 302 are firmly adhered to the second conductive layer 400. The plurality of spacers 302 divides a space between the first conductive layer 200 and the second conductive layer 400 into a plurality of lattices 304, and the liquid crystal mixture 303 is filled into the plurality of lattices 304. In an embodiment, a shape of each of the plurality of lattices 304 is polygonal.

Referring to FIG. 5, in another embodiment, a shape of each of the plurality of lattices 304 is a regular quadrilateral.

The difference between Example 4 and the above Examples is that a shape of each of the plurality of lattices 304 is a regular quadrilateral. The plurality of lattices 304 with regular quadrilaterals can be implemented in embodiments with or without a bottom plate 301.

It should be noted that the technical solutions of the various embodiments of the present disclosure may be combined with each other, but must be based on the realization by those skilled in the art. When the combination of technical solutions contradicts each other or cannot be realized, it should be considered that such combination of technical solutions does not exist and does not fall within the protection scope of the present disclosure.

The above descriptions are only preferred embodiments of the present disclosure, and are not intended to limit the patent scope of the present disclosure. All equivalent structural transformations made by using the contents of the description and drawings of the present disclosure, or directly or indirectly applied in other related technical fields, are similarly included in the scope of patent protection of the present disclosure.

1. A liquid crystal film for automotive glass, comprising:
a first base layer;
a first conductive layer disposed on the first base layer;
a second base layer opposite to the first base layer;
a second conductive layer disposed on a side of the second base layer close to the first conductive layer; and
a liquid crystal layer disposed between the first conductive layer and the second conductive layer;
wherein the liquid crystal layer comprises a plurality of spacers, and a liquid crystal mixture; the plurality of spacers is perpendicularly disposed between the first conductive layer and the second conductive layer, and divides a space between the first conductive layer and the second conductive layer into a plurality of lattices; and the liquid crystal mixture is filled in the plurality of lattices;
wherein a shape of each of the plurality of lattices is polygonal.

2. The liquid crystal film for automotive glass of claim 1, wherein the liquid crystal layer further comprises a bottom plate, the bottom plate is disposed on the second conductive layer, and the plurality of spacers is perpendicularly disposed between the bottom plate and the second conductive layer and divides a space between the bottom plate and the second conductive layer into the plurality of lattices.

3. The liquid crystal film for automobile glass of claim 1, wherein the bottom plate and the plurality of lattices are integrally formed by a curing glue.

4. The liquid crystal film for automotive glass of claim 1, wherein the shape of each of the plurality of lattices is regular hexagonal.

5. The liquid crystal film for automotive glass of claim 1, wherein the shape of each of the plurality of lattices is regular quadrilateral.

6. The liquid crystal film for automobile glass of claim 2, wherein a thickness of the bottom plate ranges from 0.01 μm to 10 μm.

7. The liquid crystal film for automobile glass of claim 1, wherein a thickness of each of the plurality of spacers ranges from 5 μm to 10 μm.

8. The liquid crystal film for automotive glass of claim 4, wherein a maximum diameter of the shape of each of the plurality of lattices ranges from 30 μm to 10 mm.

9. The liquid crystal film for automobile glass of claim 1, wherein the liquid crystal mixture is formed by mixing liquid crystal, chiral agent and glue.

10. The liquid crystal film for automobile glass of claim 1, wherein the liquid crystal mixture is formed by mixing liquid crystal, chiral agent and microparticles.

11. The liquid crystal film for automotive glass of claim 9, wherein the liquid crystal is selected from any one of GH liquid crystal, TN liquid crystal, VA liquid crystal, ECB liquid crystal, PDLC liquid crystal, PNLC liquid crystal, or PSCT liquid crystal.

12. The liquid crystal film for automotive glass of claim 1, wherein the first base layer and the second base layer are PET films or PC boards.

13. The liquid crystal film for automotive glass any one of claim 1, wherein the first conductive layer and the second conductive layer are transparent conductive layers.

14. A preparation method for liquid crystal film for automotive glass, comprising:
providing a first base layer and a second base layer;
disposing a first conductive layer on the first base layer, and disposing a second conductive layer on the second base layer;
spraying a curing glue on the second conductive layer, and imprinting a plurality of spacers on the second conductive layer by a mold, wherein a plurality of lattices is defined by the plurality of spacers;
preparing a liquid crystal mixture, and filing the liquid crystal mixture into the plurality of lattices;
covering the plurality of spacers and the plurality of lattices with the first base layer and the first conductive layer, wherein first conductive layer is disposed on tops of the plurality of spacers; and
sealing edges of the first base layer, the first conductive layer, the liquid crystal layer, the second conductive layer, and the second base layer.

15. The preparation method for liquid crystal film for automotive glass of claim 14, wherein the spraying a curing glue on the second conductive layer, and imprinting a plurality of spacers on the second conductive layer by a mold further comprises:
imprinting a bottom plate on the second conductive layer by a same mold.

16. The preparation method for liquid crystal film for automotive glass of claim 14, wherein the liquid crystal mixture is prepared by mixing liquid crystal, chiral agent and glue.

17. The preparation method for liquid crystal film for automotive glass of claim 14, wherein the liquid crystal mixture is prepared by mixing liquid crystal, chiral agent and microparticles.

18. The preparation method for liquid crystal film for automotive glass of claim 16, wherein the liquid crystal is selected from any one of GH liquid crystal, TN liquid crystal, VA liquid crystal, ECB liquid crystal, PDLC liquid crystal, PNLC liquid crystal, or PSCT liquid crystal.

19. The preparation method for liquid crystal film for automotive glass of claim 14, wherein a shape of each of the plurality of lattices is regular hexagonal.

20. The preparation method for liquid crystal film for automotive glass of claim 14, wherein a shape of each of the plurality of lattices is regular quadrilateral.
